(19) United States
(12) Patent Application Publication
(10) Pub. No.: US 2021/0086657 A1
(43) Pub. Date: Mar. 25, 2021

(54) METHOD AND APPARATUS FOR REAL TIME ELECTRIC VEHICLE EMULATION

(71) Applicant: GM GLOBAL TECHNOLOGY OPERATIONS LLC, Detroit, MI (US)

(72) Inventor: Fred W, Huntzicker, Ann Arbor, MI (US)

(73) Assignee: GM GLOBAL TECHNOLOGY OPERATIONS LLC, Detroit, MI (US)

(21) Appl. No.: 16/581,809

(22) Filed: Sep. 25, 2019

(51) Int. Cl. B60L 58/12; G07C 5/08; B60W 10/06; B60K 35/00

(52) U.S. Cl. CPC B60L 58/12; G07C 5/0816; B60K 2370/1438; B60K 35/00; B60W 10/06

(57) ABSTRACT

A method and apparatus for real time electric vehicle emulation for presentation to a combustion engine equipped vehicle operator. The emulator may include a vehicle controller for determining a current engine load on a combustion engine, a brake controller for determining a current brake application level for a vehicle, a processor operative to calculate a current vehicle performance in response to the current engine load and the current brake application level and to estimate an electric vehicle range in response to the electric vehicle performance, and a display operative to display the electric vehicle range to a vehicle operator.

### INTRODUCTION

The present disclosure relates generally to a system for emulating an electric vehicle performance in a traditional combustion engine vehicle. More specifically, aspects of the present disclosure relate to systems, methods and devices for receiving data from via a telematics system from a combustion vehicle, calculating an electric vehicle range and performance estimation in response to the received data, and presenting the range and performance estimation to a combustion vehicle user.

In manufacturing more electric vehicles and moving away from designing vehicle with internal combustion engines, manufactures face the challenge of convincing combustion vehicle purchasers to switch to electric vehicles. Some customers may be reluctant to switch to electric vehicles as the technology is unknown to them and they are unsure if the electric vehicle will be compatible with their lifestyle. For example, some customers may be reluctant to try an electric vehicle due to “range anxiety” or a fear that the electric vehicle will have insufficient range to return the customer home or that the vehicle cannot easily be recharged.

While much information is available to a potential customer as to the performance, range and recharging procedures, these generalizations may not provide the level of confidence required to assure a combustion vehicle driver that electric vehicles are suitable for their unique driving situations. It is desirable to provide a system to overcome these problems in order to provide a real time estimation of electric vehicle performance in response to an individual driver's vehicle use in order to provide an estimation of electric vehicle suitability.

The above information disclosed in this background section is only for enhancement of understanding of the background of the invention and therefore it may contain information that does not form the prior art that is already known to a person of ordinary skill in the art.

### SUMMARY

Disclosed herein are human machine interface methods and systems and related control logic for provisioning computational systems, methods for making and methods for operating such systems, and motor vehicles equipped with onboard control systems. By way of example, and not limitation, presented are various embodiments of electric propulsion vehicle performance estimations disclosed herein.

In accordance with an aspect of the present invention an apparatus having a propulsion controller for detecting a propulsion load on a combustion engine equipped vehicle, a brake controller for detecting a brake application load on the combustion engine equipped vehicle, an HVAC controller for detecting an HVAC load on the combustion engine equipped vehicle, an inertial measurement unit for detecting a force on the combustion engine equipped vehicle, an emulator for emulating an electric vehicle performance in response to the propulsion load, the brake application load, the HVAC load and the force, a processor operative to estimate an electric vehicle range and a current battery charge level in response to the electric vehicle performance, and a transmitter operative to transmit the electric vehicle range and the current battery charge level to a display for presentation to an operator of the combustion engine equipped vehicle.

In accordance with another aspect of the present invention further including a memory operative to store an initial battery charge level and wherein the current battery charge level is estimated in response to the initial battery charge level and the electric vehicle performance.

In accordance with another aspect of the present invention wherein the display is a mobile device.

In accordance with another aspect of the present invention wherein the display is a touch sensitive display mounted within a vehicle cabin.

In accordance with another aspect of the present invention further including a global positioning system sensor for detecting a current location of the combustion engine equipped vehicle and wherein the electric vehicle performance is emulated in response to a geographical characteristic of the location.

In accordance with another aspect of the present invention wherein the emulator is first operative to determine a combustion engine equipped vehicle performance in response to the propulsion load, the brake application load, the HVAC load and the force, wherein the emulator is further operative to estimate the electric vehicle performance in response to the combustion engine equipped vehicle performance.

In accordance with another aspect of the present invention further including a memory for periodically storing a value indicative of the electric vehicle performance to provide a plurality of periodically stored values and an initial battery charge level and wherein the current battery charge level is estimated in response to the initial battery charge level and a plurality of the periodically stored values.

In accordance with another aspect of the present invention further including a memory for storing an electric vehicle charging station location and a global positioning system sensor for determining a current vehicle location and wherein the processor is further operative to select the electric vehicle charging station location in response to the electric vehicle range, a user selected navigation route and the current vehicle location.

In accordance with another aspect of the present invention a method including detecting, with a vehicle controller, a propulsion load and a brake application load on a combustion engine equipped vehicle, detecting, with an HVAC controller, an HVAC load on the combustion engine equipped vehicle, detecting a force on the combustion engine equipped vehicle using an inertial measurement unit, emulating an electric vehicle performance in response to the propulsion load, the brake application load, the HVAC load and the force, estimating an electric vehicle range and a current battery charge level in response to the electric vehicle performance, and transmitting the electric vehicle range and the current battery charge level to a display for presentation to an operator of the combustion engine equipped vehicle.

In accordance with another aspect of the present invention including determining an initial battery charge level and wherein the current battery charge level is estimated in response to the initial battery charge level and the electric vehicle performance.

In accordance with another aspect of the present invention wherein the display is a mobile device and wherein the electric vehicle range and the current battery charge level are transmitted via a wireless transmission.

In accordance with another aspect of the present invention wherein the display is a vehicle cabin display screen and wherein the electric vehicle range and the current battery charge level are transmitted via a vehicle communications bus.

In accordance with another aspect of the present invention including detecting a current location of the combustion engine equipped vehicle and wherein the electric vehicle performance is emulated in response to a geographical characteristic of the location.

In accordance with another aspect of the present invention including determining a combustion engine equipped vehicle performance in response to the propulsion load, the brake application load, the HVAC load and the force and wherein the electric vehicle performance is estimated in response to the combustion engine equipped vehicle performance.

In accordance with another aspect of the present invention including periodically storing, in a memory, a value indicative of the electric vehicle performance to provide a plurality of periodically stored values and an initial battery charge level and wherein the current battery charge level is estimated in response to the initial battery charge level and a plurality of the periodically stored values.

In accordance with another aspect of the present invention including storing, in a memory, an electric vehicle charging station location and determining a current vehicle location, using a global positioning system sensor, and selecting the electric vehicle charging station location in response to the electric vehicle range, a user selected navigation route and the current vehicle location.

In accordance with another aspect of the present invention an electric vehicle performance emulator including a vehicle controller for determining a current engine load on a combustion engine, a brake controller for determining a current brake application level for a vehicle, a processor operative to calculate a current vehicle performance in response to the current engine load and the current brake application level and to estimate an electric vehicle range in response to the electric vehicle performance, and a display operative to display the electric vehicle range to a vehicle operator.

In accordance with another aspect of the present invention including a memory for storing an initial battery charge level and wherein the processor is further operative to calculate a current battery charge level in response to the initial battery charge level and the current vehicle performance and wherein the display is further operative to display the current battery charge level.

In accordance with another aspect of the present invention including a global positioning system sensor for detecting a current vehicle location and wherein the current vehicle performance is calculated in response to a geographical characteristic of the current location.

In accordance with another aspect of the present invention including a memory for periodically storing a value indicative of the current vehicle performance to provide a plurality of periodically stored values and an initial battery charge level and wherein a current battery charge level is estimated in response to the initial battery charge level and a plurality of the periodically stored values and wherein the display is further operative to display the current battery charge level.

The above advantage and other advantages and features of the present disclosure will be apparent from the following detailed description of the preferred embodiments when taken in connection with the accompanying drawings.

### BRIEF DESCRIPTION OF THE DRAWINGS

The exemplary embodiments will hereinafter be described in conjunction with the following drawing figures, wherein like numerals denote like elements, and wherein:

FIG. 1 shows an exemplary environment for real time electric vehicle emulation according to an exemplary embodiment of the present disclosure.

FIG. 2 shows an application for real time electric vehicle emulation according to an exemplary embodiment of the present disclosure.

FIG. 3 shows a flow chart illustrating a method for real time electric vehicle emulation according to an exemplary embodiment of the present disclosure.

FIG. 4 shows a user interface for real time electric vehicle emulation according to another exemplary embodiment of the present disclosure.

FIG. 5 shows another flow chart illustrating a method for real time electric vehicle emulation according to an exemplary embodiment of the present disclosure.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

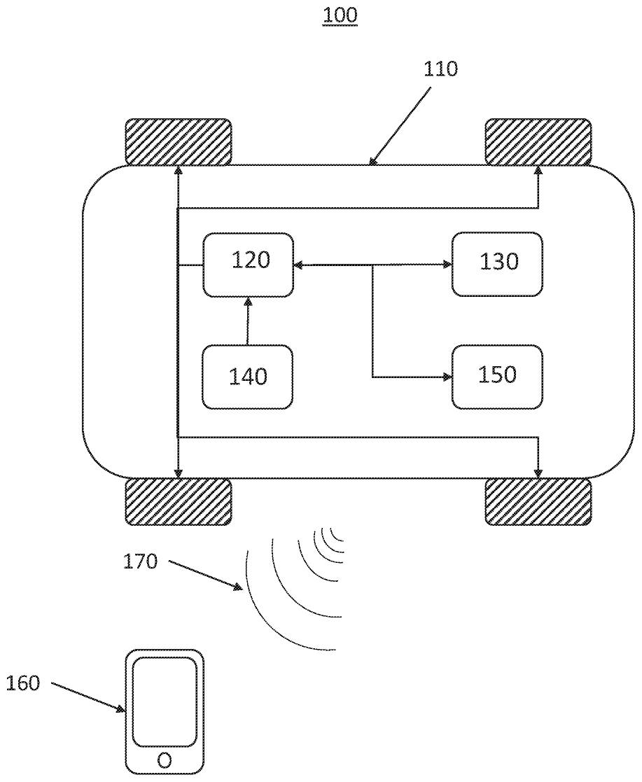

Turning now to FIG. 1, an exemplary environment 100 for real time electric vehicle emulation according to an exemplary embodiment of the present disclosure is shown. The exemplary environment 100 may include a combustion engine powered vehicle 110 having a vehicle controller 120, a heating, ventilation, and air conditioning (HVAC) controller 140, a propulsion controller 130 and a telematics device 150. The exemplary environment 100 may further include a mobile device 160 for receiving a wireless signal 170 from the vehicle 110.

A problem arising with a driver's transition from combustion vehicles to electric vehicles is a fear that a driver may be left stranded with an electric vehicle that doesn't have enough charge to return home and that no remote chargers are available to easily recharge the electric vehicle. This ‘range anxiety” is therefore a significant barrier to drivers transitioning from combustion to electric vehicles. The proposed system and method facilitate a potential electric vehicle customer emulating the driving of an electric vehicle, thereby experiencing how regeneration and charging works. For example, while driving the vehicle 110 in their individual style, the driver may see how an electric vehicle would perform accordingly and if an electric vehicle will work for them. While it is easy to generalize someone's range through calculations, each customer may still feel that their situation is unique. By collecting real data on the driver's current internal combustion propulsion vehicle, the driver may be presented with an emulated electric vehicle to determine if an electric vehicle meets their need.

The vehicle controller 120 is operative to generate control signals in response to a driver input, such as steering, braking, and throttle adjustments. The vehicle controller 120 is operative to process and couple these control signals to the various vehicle control systems as well as the propulsion unit. The vehicle controller is further operative to save these control instructions as well as other vehicle dynamics information, such as speed, accelerations, road slope, etc. which may be collected in response to an inertial measurement unit or the like, and to couple this information to the telematics device 150. The vehicle controller 120 may further be operative to receive information from the HVAC controller 170 indicative of current HVAC settings, cabin temperature, etc. The vehicle controller 120 may be further operative to couple this HVAC information to the telematics device 150 or in may be coupled directly from the HVAC controller 140 to the telematics device 150.

In this exemplary embodiment, the telematics device 150 is operative to wireless transmit via a wireless signal 170, such as a radio frequency signal, the received data to a mobile device 160. The mobile device 160 is operative to emulate the electric vehicle operation in response to the received data such as vehicle speed, acceleration, brake status, temperature, vehicle power mode and the like. In response to this data, software on the mobile device 160 may be operative to display to a user simulated electric vehicle battery charge remaining, power in and out, etc. The mobile device 160 may be further operative to compare the combustion powered vehicle performance to the simulated electric vehicle performance and display potential costs and savings for each vehicle. The mobile device 160 may further simulate charging time and type when a vehicle is parked at the driver's home or near a remote charging location. The mobile device 160 may also display proximate charging stations.

In this exemplary environment 100, the mobile device 160 is operative to simulate the performance of a simulated electric vehicle in response to actual allowing the electric vehicle performance to be demonstrated in real time to a driver. This real time demonstration may allow a driver to overcome range anxiety when the driver can determine, in response to actual vehicle usage, that the electric vehicle may be suitable for the driver's use. In this exemplary embodiment, the vehicle data is collected by the telematics device 150 and is transmitted to the mobile device 160. However, data may be alternatively collected by a dongle, Bluetooth or Wi-Fi connection to a mobile device or the like. The dongle or telematics device 150 may be connected to the vehicle controller via an OBDII port, USB port, Assembly Line Diagnostic Link (ALDL) or the like. In addition, the simulated electric vehicle performance may be displayed on a vehicle application, a vehicle display, a mobile app, or a personal computer and/or web browser.

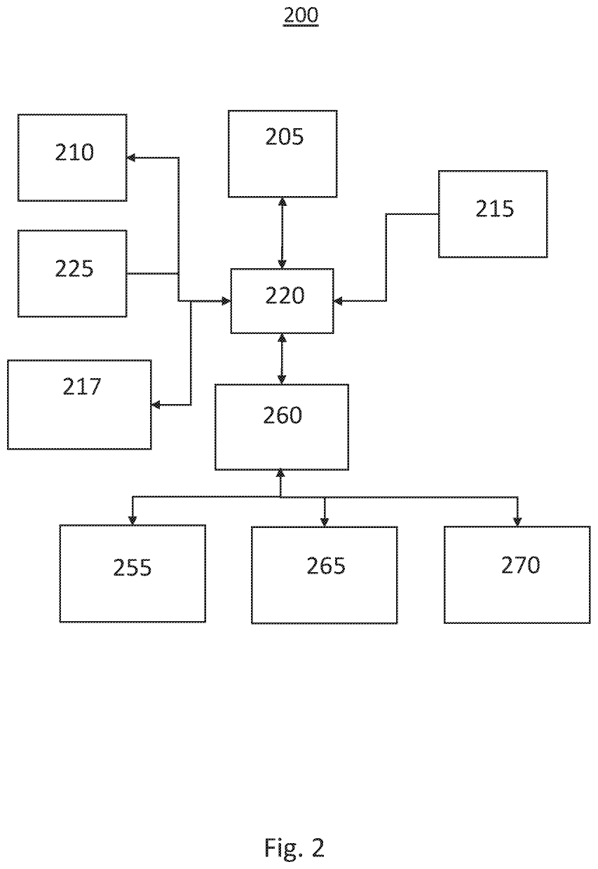

Turning now to FIG. 2, an exemplary system 200 for real time electric vehicle emulation according to an exemplary embodiment of the present disclosure is shown. The exemplary system 200 includes an HVAC controller 205, a transmitter 210, a global positioning system (GPS) sensor 215, an inertial measurement unit (IMU) 225, a processor 220, a user interface 217, a vehicle controller 260, a throttle controller 255, a brake controller 265, and a steering controller 270.

The transmitter 210 may be operative to receive data from the processor 220 and to transmit this data to a display device for display to a vehicle operator. The display may be a mobile device and the data may be transmitted wirelessly via a Bluetooth, Wi-Fi, or radio frequency signal. The data may be indicative of an electric vehicle performance predicted in response to a combustion engine equipped vehicle operation by the vehicle operator. The data may include predicted battery charge level, predicted vehicle range, etc.

The IMU 233 is a device used to report a specific force of a body. The IMU 233 may measure angular or linear acceleration and may be used to determine a lateral acceleration, a longitudinal acceleration, a yaw rate and pitch of a vehicle. The IMU 233 is mounted within the host combustion engine equipped vehicle and is operative to generate a control signal indicative of the measured specific forces and to couple this control signal to the processor 220.

The user interface 217 may be operative to provide a human machine interface between the vehicle control system and the driver. The user interface 217 may be a touch sensitive display screen, a display, one or more buttons, dials, switches, etc., and or one or more light emitting diodes, audio generation devices, such as a speaker, or other indicators. The user interface 217 is operative to receive user requests such as a request for activating a vehicle system, such as settings for an HVAC system. In an exemplary embodiment of the present disclosure, the user interface 217 may be operative to receive emulated data indicative of an electric vehicle performance generated by the processor 220 and to display this emulated data to a vehicle operator. The emulated data may include predicted battery charge level, predicted vehicle range, etc., of a simulated electric vehicle.

The vehicle controller 260 may be operative to control the vehicle operations in response to a control algorithm or the like. In an exemplary embodiment, the vehicle controller 260 may be operative to generate vehicle control signals for coupling to a throttle controller 255, a brake controller 265, and a steering controller 270 or the like for control of the vehicle in response to an advanced driver assistance system (ADAS) algorithm or in response to a vehicle operator input via a steering wheel, vehicle pedals, and the like. The vehicle controller 260 may further be operative to generate system control signals for coupling to the processor 220, indicative of such information as speed of the vehicle, acceleration, vehicle motion cycles, vehicle operator input state, etc.

The processor 220 may be operative to received data from the vehicle controller 260, the IMU 225, the user interface 217, and the GPS 215 to emulate the performance of an electric vehicle in response to the measured performance of a combustion engine equipped vehicle. In an exemplary embodiment, the processor 220 may be operative to receive throttle state information and brake state information from the vehicle controller 260, vehicle velocity and acceleration from the IMU 225, vehicle location and elevation from the GPS 215, and HVAC setting from the HVAC controller 205 in order to determine a current energy demand on the combustion engine equipped vehicle. The processor 220 may then use the current energy demand on the combustion engine equipped vehicle to determine an estimated energy demand of an emulated electric vehicle. The estimated energy demand may be used to predict an estimated range of the emulated electric vehicle. This estimated range may then be coupled to the transmitter 210 or the user interface 217 for display to a vehicle operator.

Likewise, the estimated energy demand may be used to estimate an estimated charge level of an emulated electric vehicle battery. The processor 220 may be operative to determine total HVAC energy consumption, distance driven, and/or total energy demand of the combustion engine equipped vehicle during a current trip and to estimate a total energy consumption for the current trip and/or since the last virtual battery charging. The processor 220 may determine a current battery charge level in response to the total energy consumption since the last virtual battery charging and couple this current battery charge level to the transmitter 210 or the user interface 217 for display to the vehicle operator.

In another exemplary embodiment, the user interface 217 may be a mobile device wherein the processor 220, IMU 225 and GPS 215 are integral to the mobile device. The processor 220 in this exemplary embodiment may receive data from the IMU 225 and the GPS 215 and estimate energy demand and battery charge level of a simulated electric vehicle without data from an actual vehicle. For example, the mobile device may sense movement above a certain velocity and determine that the mobile device is in a vehicle. The mobile device may then display an estimated battery charge level and/or estimated energy demand in response to the data provided by the IMU 225 and GPS 215 within the mobile device. In addition, the mobile device may be operative to store a travel timeline for the mobile device and calculate an electric vehicle energy demand for the travel timeline and to display the electric vehicle energy demand to a user on the user interface 217.

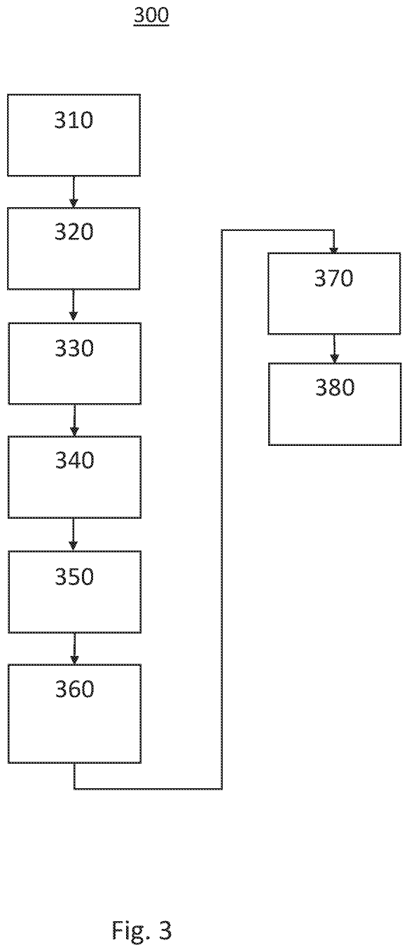

Turning now to FIG. 3, an exemplary method 300 for real time electric vehicle emulation according to an embodiment of the present disclosure is shown. The exemplary method 300 is first operative to determine 310 an initial battery charge level in response to a previous virtual battery charge session. The initial battery charge level may be determined in response to situation or indication from a user that an electric vehicle would be available for charging. For example, when a combustion engine equipped vehicle is parked at the vehicle operator's residence, the system may be programmed to assume that if the vehicle were an electric vehicle, that it would be available for charging. Likewise, if a vehicle is parked for a duration of time near an available charger, such as in a parking structure or the like, the method may assume that an electric vehicle could be attached to the charger for the time duration that the vehicle is stationary.

In an exemplary embodiment, a combustion engine equipped vehicle returns to a vehicle operators' residence at 11 pm and departs the residence at 6 am, the method may assume that an electric vehicle would have been available for charging for seven hours. The method may then determine how much the battery could be charged in the 7 hours and add this amount to the battery charge level indicated when the vehicle arrived at the residence. For example, if when arriving at the residence at 11 pm, the electric vehicle emulator indicated a 20% available charge, and that it may be estimated that an electric vehicle battery may be charged 10% per hour for a certain type of charger, the electric vehicle emulator may determine an initial battery charge of 90% when the vehicle departs the residence at 6 am.

The method may be further operative to determine an initial battery charge level for different types of chargers which could be installed at a driver's residence. For example, a level 1 charger which plugs into a standard 115 VAC household outlet may provide 1.5 kW and charge a battery 0.025% per hour. A level 2 7 kW charger which requires a 230 VAC 30A outlet may charge a battery 1.2% per hour. The method may further calculate charge rates for other types of chargers, such as DC fast chargers, and to present these estimations to the vehicle operator via the user interface. Further, the method may provide the vehicle operator an opportunity to select a type of charger to be used in the electric vehicle emulation algorithm.

The method is next operative to determine 320 a current energy consumption rate for a combustion engine equipped vehicle during vehicle operation. The current energy consumption may be determined in response to data received from the vehicle controller, GPS, IMU, and HVAC controller of the combustion engine equipped vehicle. The current energy consumption of the combustion engine equipped vehicle is first determined in response to data such as vehicle speed, average acceleration, road incline, average speed, HVAC load, altitude, road characteristics and the like.

In response to the current energy consumption rate of the combustion engine equipped vehicle, the method is next operative to determine 330 a current estimated energy consumption of an emulated electric vehicle. In one exemplary embodiment, the weight and fuel economy of the combustion engine equipped vehicle may be compared to that of an electric vehicle to determine an estimated energy consumption rate of an emulated electric vehicle. Alternatively, the method may use current combustion engine equipped vehicle dynamics to estimate the energy consumption rate of an emulated electric vehicle. The current estimated energy consumption rate of the emulated electric vehicle may be estimated from an average number of periodically determined estimated energy consumption rates. The method may further be operative to periodically store determined estimated energy consumption rates in a memory or the like.

The method is next operative to estimate 340 a current virtual battery level in response to the determined estimated energy consumption rates of the emulated electric vehicle and the initial battery charge level. In one exemplary embodiment, the current battery level may be determined in response to the estimated energy consumption rate for the duration of the current trip subtracted from the initial battery charge level. Alternatively, the current battery charge level may be determined in response to the stored periodically estimated energy consumption rates. The energy consumption for each of the periodic time intervals is estimated and the sum of these estimated energy consumptions are subtracted from the initial battery charge level to estimate a current virtual battery level.

In response to the current virtual battery level and the estimated energy consumption rates, the method is next operative to estimate 350 a current estimated range for an emulated electric vehicle. In one exemplary embodiment, the current estimated range is estimated as the quotient of the current virtual battery level by the estimated energy consumption rate for the emulated electrical vehicle.

The method is next operative to transmit 360 the current virtual battery level and current estimated range to a display for presentation to a vehicle operator. The display may be a mobile device, a display within a vehicle cabin, or the current virtual battery level and current estimated range may be transmitted to a cloud server and presented to a vehicle operator in response to a request generated by the vehicle operator.

In addition, the method may further be operative to determine 370 a charging station location in response to navigation route and current estimated range. The navigational route may be generated in response to a user input indicative of a destination and the current location of the vehicle. The method is then operative to determine a location convenient to the navigational route close to the destination or close to the current estimated range along the navigational route. For example, if the navigational route is 100 miles long and the current estimated range is 70 miles, the method may be operative to determine charging station locations round 60 miles along the navigational route. The method is then operative to transmit 380 the locations of the determined charging stations for display to a vehicle operator. The locations of the determined charging stations may be transmitted to a mobile device, in cabin display or the like for presentation to the vehicle operator.

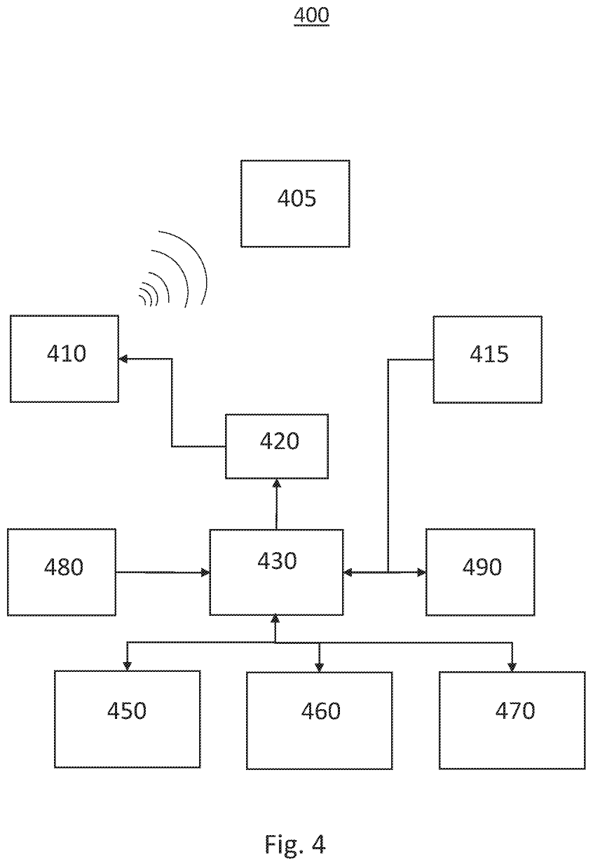

Turning now to FIG. 4, another exemplary system 400 for real time electric vehicle emulation according to an embodiment of the present disclosure is shown. The exemplary system 400 may include a transmitter 410 for transmitting to a display 405, a GPS sensor 415, a processor 420, an IMU 480, an emulator 430, a memory 490, a propulsion controller 450, a brake controller 460 and an HVAC controller 470.

The propulsion controller 450 is operative for detecting a propulsion load on a combustion engine equipped vehicle. In one exemplary embodiment, the propulsion load may be detected in response to a combustion engine horsepower, brake power and/or torque at an engine speed. Alternatively, propulsion load may be estimated in response to velocity and acceleration of the vehicle, vehicle weight, aerodynamic factors, geographical characteristics, such as a hilly road or the like. The propulsion controller may further be operative for detecting a brake application load on the vehicle. The brake application load may be determined in response to a brake pedal position, a brake system pressure measurement, and/or an acceleration and velocity measurement from an IMU 480. The IMU 480 is a device operative to detect lateral, longitudinal and rotational forces on a vehicle. These forces may be used to estimate an acceleration of the vehicle, road characteristics, vehicle handling characteristics and the like. The forces may further be used to estimate a vehicle weight, trailering state or configuration and the like.

The HVAC controller 470 may be used for detecting an HVAC load on the combustion engine equipped vehicle. The HVAC system may be a significant source of an electric vehicle energy consumption. In a combustion engine equipped vehicle, the HVAC system employs a fan and air conditioning compressor driven by the combustion engine to provide cooling to the vehicle cabin. Heat is typically provided in a combustion engine equipped vehicle by extracting heat from the engine coolant system and blowing this heated air into the vehicle cabin. In an electric vehicle, electrical resistive elements may be used to heat the vehicle cabin and the air conditioning system is driven by an electric motor or the like. In estimating an electric vehicle performance, the HVAC load is determined in response to the HVAC controller parameters.

An emulator 430 is used for emulating the electric vehicle performance in response to the propulsion load, the brake application load, the HVAC load and the forces measured by the IMU 480. These performance parameters may be combined with static characteristics of an electric vehicle, such as aerodynamic performance, energy combustion, weight, etc., to emulate the electric vehicle performance in response to the combustion engine equipped vehicle performance. In an exemplary embodiment, the emulator may first be operative to determine a combustion engine equipped vehicle performance in response to the propulsion load, the brake application load, the HVAC load and the total forces on the vehicle and to estimate the electric vehicle performance in response to the combustion engine equipped vehicle performance. The emulator 430 may be a microprocessor, an ADAS controller, a vehicle controller, or the like. The emulation may be performed on a vehicle based processor or a processor in a remote or mobile device.

A processor 420 may then be used to estimate an electric vehicle range and a current battery charge level in response to the electric vehicle performance and the electric vehicle range and the current battery charge level are coupled to a transmitter for transmission to a display 405 for presentation to an operator of the combustion engine equipped vehicle. The transmitter may be a wireless transmitter for coupling to a mobile device, such as a cellular phone, or a vehicle communications bus for coupling to a vehicle cabin display or the like.

The exemplary system 400 may further include a memory operative to store an initial battery charge level and wherein the current battery charge level is estimated in response to the initial battery charge level and the electric vehicle performance. A GPS sensor 415 may be used for detecting a current location of the combustion engine equipped vehicle and wherein the electric vehicle performance is emulated in response to a geographical characteristic of the location. In an exemplary embodiment the memory 490 may be operative for periodically receiving a value indicative of the electric vehicle performance from the emulator 430 and for storing the values to generate a plurality of periodically stored values. The memory 490 may further store an initial battery charge level such that a current battery charge level may be estimated in response to the initial battery charge level and a plurality of the periodically stored values. The memory may be further operative for storing an electric vehicle charging station location. In response to the electric vehicle charging location, a current vehicle location detected by the GPS sensor 415, the processor 420 or emulator 430 may be further operative to select the electric vehicle charging station location in response to the electric vehicle range, a user selected navigation route and the current vehicle location.

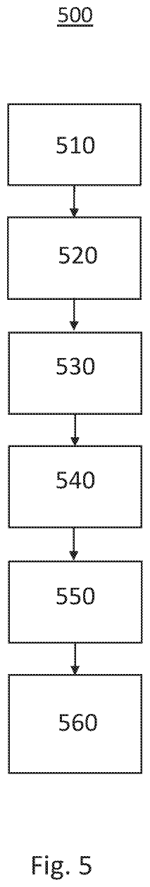

Turning now to FIG. 5, another exemplary method 500 for real time electric vehicle emulation according to an embodiment of the present disclosure is shown. The method is first operative to detect 510 a propulsion load and a brake application load on a combustion engine equipped vehicle. The propulsion load and brake application load may be determined by a vehicle controller, propulsion controller, brake controller, throttle controller and/or by a processor using data from these controllers. The data may be transmitted to the processor by a vehicle communications bus or the like. The method is next operative to detect 520 an HVAC load on the combustion engine equipped vehicle. The HVAC load may be detected in response to detected operating parameters of an HVAC controller, inside and outside temperature, fresh air inlet settings, etc. The method is next operative to detect 530 a force on the combustion engine equipped vehicle using an inertial measurement unit.

The method is next operative for emulating 540 an electric vehicle performance in response to the propulsion load, the brake application load, the HVAC load and the force. In an additional exemplary embodiment, the method may detect a current location of the combustion engine equipped vehicle and the electric vehicle performance is emulated in response to a geographical characteristic of the location. Geographical characteristics of the location may be stored with map data in a memory. In another exemplary embodiment, a combustion engine equipped vehicle performance may be determined in response to the propulsion load, the brake application load, the HVAC load and the force. The electric vehicle performance may then be estimated in response to the combustion engine equipped vehicle performance.

The method is next operative for estimating 550 an electric vehicle range and a current battery charge level in response to the electric vehicle performance. The method is then operative to transmit 560 the electric vehicle range and the current battery charge level to a display for presentation to an operator of the combustion engine equipped vehicle. In one embodiment the display is a mobile device, such as a smartphone and the electric vehicle range and the current battery charge level are transmitted via a wireless transmission, such as a Bluetooth transmission or radio frequency transmission. In an alternative embodiment, the display is a vehicle cabin display screen and the electric vehicle range and the current battery charge level are transmitted via a vehicle communications bus.

In additional embodiments, the exemplary method may further be operative for determining an initial battery charge level and wherein the current battery charge level is estimated in response to the initial battery charge level and the electric vehicle performance. In addition, the method may further include periodically storing, in a memory, a value indicative of the electric vehicle performance to provide a plurality of periodically stored values and an initial battery charge level and wherein the current battery charge level is estimated in response to the initial battery charge level and a plurality of the periodically stored values. In addition, electric vehicle charging station locations may be stored in the memory and presented to a vehicle operation in response to determining a current vehicle location, using a global positioning system sensor, and selecting the electric vehicle charging station location in response to the electric vehicle range, a user selected navigation route and the current vehicle location.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An apparatus comprising:
a propulsion controller for detecting a propulsion load on a combustion engine equipped vehicle;
a brake controller for detecting a brake application load on the combustion engine equipped vehicle;
an HVAC controller for detecting an HVAC load on the combustion engine equipped vehicle;
an inertial measurement unit for detecting a force on the combustion engine equipped vehicle;
an emulator for emulating an electric vehicle performance in response to the propulsion load, the brake application load, the HVAC load and the force;
a processor operative to estimate an electric vehicle range and a current battery charge level in response to the electric vehicle performance; and
a transmitter operative to transmit the electric vehicle range and the current battery charge level to a display for presentation to an operator of the combustion engine equipped vehicle.

2. The apparatus of claim 1 further including a memory operative to store an initial battery charge level and wherein the current battery charge level is estimated in response to the initial battery charge level and the electric vehicle performance.

3. The apparatus of claim 1 wherein the display comprises a mobile device.

4. The apparatus of claim 1 wherein the display comprises a touch sensitive display mounted within a vehicle cabin.

5. The apparatus of claim 1 further including a global positioning system sensor for detecting a current location of the combustion engine equipped vehicle and wherein the electric vehicle performance is emulated in response to a geographical characteristic of the location.

6. The apparatus of claim 1 wherein the emulator is first operative to determine a combustion engine equipped vehicle performance in response to the propulsion load, the brake application load, the HVAC load and the force, wherein the emulator is further operative to estimate the electric vehicle performance in response to the combustion engine equipped vehicle performance.

7. The apparatus of claim 1 further including a memory for periodically storing a value indicative of the electric vehicle performance to provide a plurality of periodically stored values and an initial battery charge level and wherein the current battery charge level is estimated in response to the initial battery charge level and a plurality of the periodically stored values.

8. The apparatus of claim 1 further including a memory for storing an electric vehicle charging station location and a global positioning system sensor for determining a current vehicle location and wherein the processor is further operative to select the electric vehicle charging station location in response to the electric vehicle range, a user selected navigation route and the current vehicle location.

9. A method comprising:
detecting, with a vehicle controller, a propulsion load and a brake application load on a combustion engine equipped vehicle;
detecting, with an HVAC controller, an HVAC load on the combustion engine equipped vehicle;
detecting a force on the combustion engine equipped vehicle using an inertial measurement unit;
emulating an electric vehicle performance in response to the propulsion load, the brake application load, the HVAC load and the force;
estimating an electric vehicle range and a current battery charge level in response to the electric vehicle performance; and
transmitting the electric vehicle range and the current battery charge level to a display for presentation to an operator of the combustion engine equipped vehicle.

10. The method of claim 9 further including determining an initial battery charge level and wherein the current battery charge level is estimated in response to the initial battery charge level and the electric vehicle performance.

11. The method of claim 9 wherein the display comprises a mobile device and wherein the electric vehicle range and the current battery charge level are transmitted via a wireless transmission.

12. The method of claim 9 wherein the display comprises a vehicle cabin display screen and wherein the electric vehicle range and the current battery charge level are transmitted via a vehicle communications bus.

13. The method of claim 9 further including detecting a current location of the combustion engine equipped vehicle and wherein the electric vehicle performance is emulated in response to a geographical characteristic of the location.

14. The method of claim 9 further including determining a combustion engine equipped vehicle performance in response to the propulsion load, the brake application load, the HVAC load and the force and wherein the electric vehicle performance is estimated in response to the combustion engine equipped vehicle performance.

15. The method of claim 9 further including periodically storing, in a memory, a value indicative of the electric vehicle performance to provide a plurality of periodically stored values and an initial battery charge level and wherein the current battery charge level is estimated in response to the initial battery charge level and a plurality of the periodically stored values.

16. The method of claim 9 further including storing, in a memory, an electric vehicle charging station location and determining a current vehicle location, using a global positioning system sensor, and selecting the electric vehicle charging station location in response to the electric vehicle range, a user selected navigation route and the current vehicle location.

17. An electric vehicle performance emulator comprising:
an inertial measurement unit for determining a current acceleration;
a global positioning system for determining a current location;
a processor operative to calculate an estimated vehicle performance in response to the current acceleration and the current location and to estimate an electric vehicle range in response to the estimated vehicle performance; and
a display operative to display the electric vehicle range to a user.

18. The electric vehicle performance emulator of claim 17 further including a memory for storing an initial battery charge level and wherein the processor is further operative to calculate a current battery charge level in response to the initial battery charge level and the estimated vehicle performance and wherein the display is further operative to display the current battery charge level.

19. The electric vehicle performance emulator of claim 17 further including a receiver for receiving a vehicle performance data from a vehicle and wherein the estimated vehicle performance is calculated in response to the vehicle performance data.

20. The electric vehicle performance emulator of claim 17 further including a memory for periodically storing a value indicative of the estimated vehicle performance to provide a plurality of periodically stored values and an initial battery charge level and wherein a current battery charge level is estimated in response to the initial battery charge level and a plurality of the periodically stored values and wherein the display is further operative to display the current battery charge level.
